(19) United States
(12) Patent Application Publication
(10) Pub. No.: US 2004/0016325 A1
(43) Pub. Date: Jan. 29, 2004

(54) Ultra-locks

(76) Inventor: Jesse Giang Smith, Dover, DE (US)

Correspondence Address: John C. Andrade, P.O. Box 598, Dover, DE, 19903, US

(21) Appl. No.: 10/119,580

(22) Filed: Apr. 10, 2002

(51) Int. Cl. B25B 7/02

(52) U.S. Cl. 81/424.5

(57) ABSTRACT

Adjustable pliers comprising a round jaw and teeth on every gripping surface of the jaw. The teeth extend down the body of the pliers to the extent that the jaws, when fully opened are able to grip an object from every surface of the jaw.

### BACKGROUND

The current invention relates to adjustable pliers, such as those commonly referred to as channel-lock pliers, water pump pliers, or slip joint pliers. Current pliers can only grip a surface from two to three points at best. When applied to round objects such as pipes, they do not always hold and tend to slip. The present invention deals with this problem in two ways: First, by addressing the shape of the jaws, and, Second, by adding additional teeth, enabling the pipe to be gripped uniformly around half its diameter.

### SUMMARY OF THE INVENTION

The pliers differ from standard adjustable pliers first by the shape of its jaw. The Ultra-Lock pliers have a round jaw, such that when the pliers are adjusted to a central position, the back portion of the jaw forms a perfect half-circle. This enables the jaws to surround a pipe and creates an infinite amount of gripping points between the pliers and the pipe. A notch can be added on the lower portion of the jaw enabling larger objects to be gripped by the same set of pliers. The pliers can be made in a variety of sizes so that they can be used for all size pipes. The additional teeth give superior gripping power to the jaws of the pliers. They allow several points of contact around half the pipe as well as providing a better grip on other types of objects of differing shape. The teeth themselves could also be used on a standard shaped adjustable pliers giving it the same gripping advantage. The teeth on any shape of pliers can be further extended so that they would cover every surface of the jaw when the jaws are opened to their fullest extent.

The preferred embodiment would encompass both the shape and teeth features of the invention, but it must be noted that the features could be used alone or in combination.

The pliers can be made out of a variety of materials, both metallic and non-metallic or any combination thereof, depending upon their use.

The first embodiment of the invention is an adjustable pliers comprised of two members forming a jawed mouth on one end, handles on the other end, and pivot about an axle point. Said members have an inner and outer side with said axle point mounted on one of said members on the inner side and the other of said members having an elongated slot, extending longitudinally down the second member from the jawed mouth to the handle, in which said axle point moves to allow for adjustment of the size of said jawed mouth. Said slot has a means for selective positioning of said axle point along said slot. Said inner portions of said members contain a guide means comprised of channels along one inner portion and a protruding notch along the other inner portion, said notch fitting into the selected channel guiding the opening and closing of said mouth.

The jawed mouth has a series of saw-tooth shaped teeth along the upper and lower portion of said mouth. The mouth is in a shape of a standard set of adjustable pliers, having a flat edge along the backside of the jaw, but wherein said teeth extend down the jaw to a point wherein every portion of the jaw would have a tooth on every section of the jaw when the jaws are opened to their fullest extent.

The second embodiment of the invention claimed is an adjustable pliers wherein the back end of the lower jaw section turns upward at such angle as to form one-quarter of a circle and the back end of the upper jaw section turns downward at the same angle, said back ends of the upper and lower jaw sections forming two sloped sections together which form a half-circle when the axle point is positioned at the center of the slot. The half-circle comprises the back end of the jaw, and said half circle contains no teeth.

The third embodiment of the invention claimed has the half-circle jaw shape of the second embodiment, but further comprises additional teeth extending down the two sloped sections allowing the jaw to encircle any round shaped object and grip said object uniformly along half its diameter with said teeth.

The fourth embodiment of the invention claimed would have the additional teeth of the third embodiment continue up both members forming the jaws beyond the point where a half circle is formed along the straight edge on the inner side of the second member to a point wherein the teeth would be able to grab any object when the jaws are opened to their fullest extent.

The fifth embodiment has an additional indentation along the straight edge described in the fourth embodiment. The indentation contains additional saw-tooth shaped teeth, and could be in either a crescent shape or a V-shape. The inner angle of the V-shaped indentation could range from 110 to 150 degrees, but an angle of 150 degrees is preferable. This indentation allows for improved gripping of larger pipes and other odd-shaped materials.

### BRIEF DESCRIPTION OF THE DRAWINGS

The invention is further described in connection with the accompanied drawings which:

FIG. 1 is a left side view of an embodiment of the present invention, in the form of channel-lock pliers, showing the additional teeth along the back end of the jawed mouth.

FIG. 2 is a right side view of the present invention showing the extent that the additional teeth run down the flat edge of one of the two members forming the pliers.

FIG. 3 is a view of the jaws of a pair of pliers forming a half circle, as per another embodiment of the invention.

FIG. 4 is a view of the half circle jaw of FIG. 3 with additional teeth extending around the circular portion of the jaw.

FIG. 5 is a view of the half circle of FIG. 4 with additional teeth extending beyond the circular portion of the jaw.

FIG. 6A shows an elliptical notch at the rear of the jaw of the pliers.

FIG. 6B shows an angled notch at the rear of the jaw of the pliers.

### DETAILED DESCRIPTION OF THE INVENTION

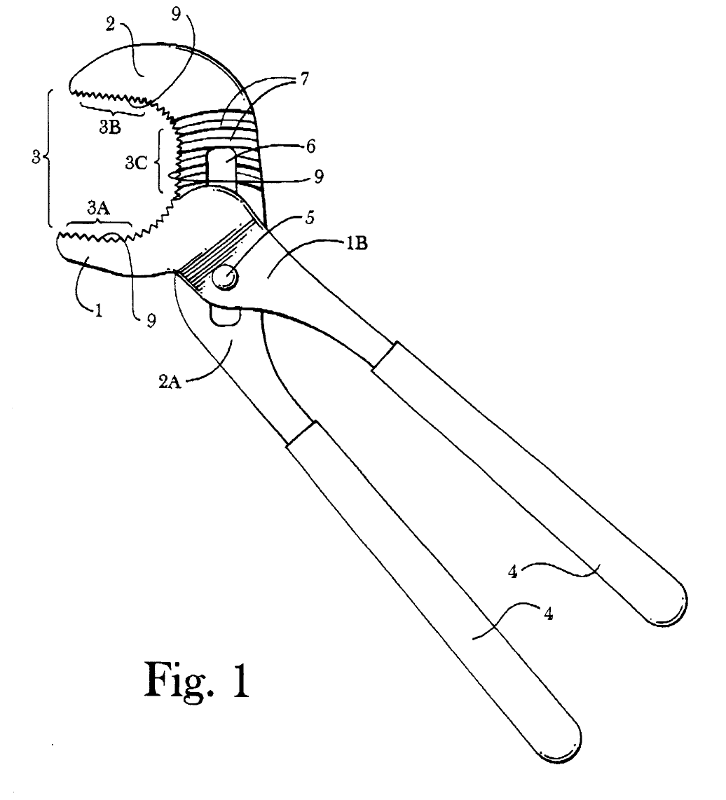

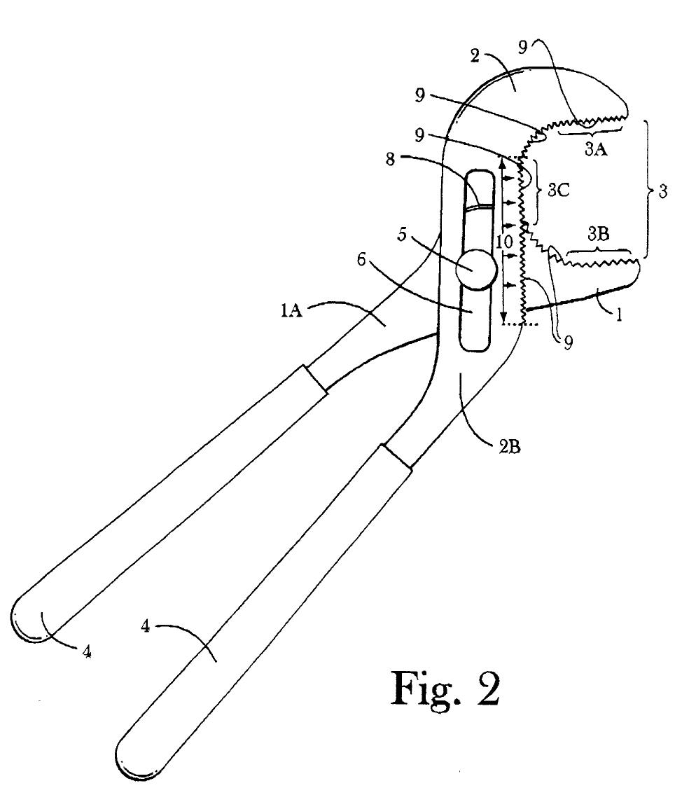

FIGS. 1 & 2 show a standard shaped adjustable pliers with additional teeth. It is comprised of a first member and second members 1 & 2 forming a jawed mouth 3 on one end, handles 4 on the other end, and an axle point 5 joining the two members. Said members have an inner 1A & 2A and outer 1B & 2B side with said axle point 5 mounted on said first members 1 on the inner side 1A and said second member 2 having an elongated slot 6 extending longitudinally down the second member 2 from the jawed mouth 3 to the handles 4, in which said axle point 5 moves to allow for adjustment of the size of the jawed mouth 3. Said slot 6 having a means for selective positioning of said axle point 5 along said slot 6. Said inner sides 1A & 2A of said members 1 & 2 contain a guide means comprised of channels 7 along one inner side 2A and a protruding notch 8 along the other inner side 1A, said notch 8 fitting into the selected channel 7 guiding the opening and closing of said mouth 3. The jawed mouth 3 has a series of saw-tooth shaped teeth 9 along the upper 3A and lower 3B portions of the mouth. The mouth is in the shape of a standard set of adjustable pliers, having a flat edge 10 on said second member along the backside of the jaw 3C, but wherein said teeth 9 extend down the jaw to a point wherein every portion of the jaw would have a tooth 9 on every section of the jaw when the jaws are open to their fullest extent.

FIG. 3 shows the second embodiment of the invention which is an adjustable pliers wherein the backside of the jaw 3C forms a half-circle 11 when the axle point 5 is positioned in the center of the slot 6. The jawed mouth 3 has a series of saw-tooth shaped teeth 9 along the upper 3A and lower 3B portions of the mouth.

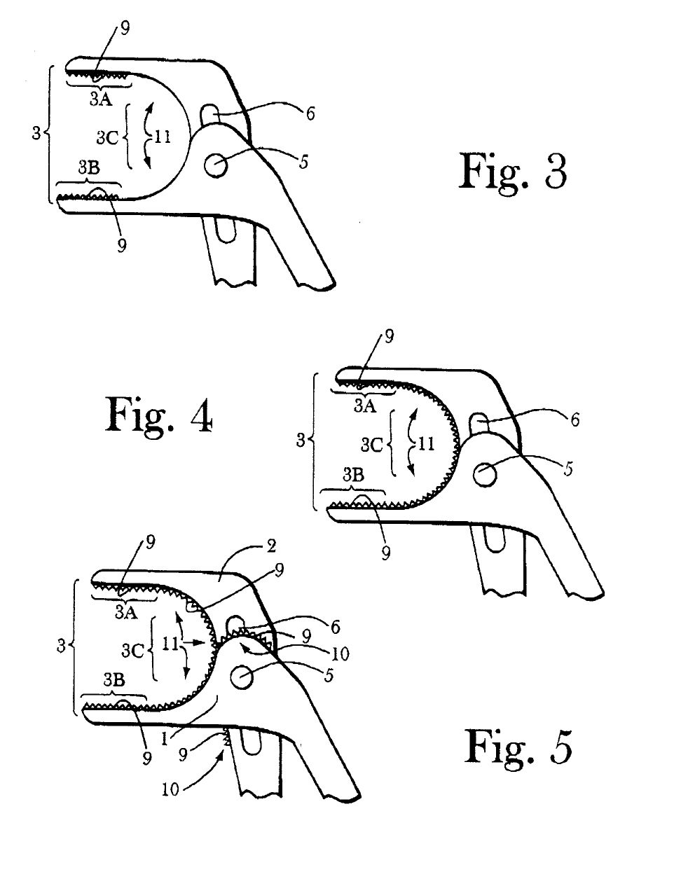

FIG. 4 shows the third embodiment of the invention which is an adjustable pliers wherein the backside of the jaw 3C forms a half-circle 11 when the axle point 5 is positioned in the center of the slot 6. The jawed mouth 3 has a series of saw-tooth shaped teeth 9 along the upper 3A, lower 3B and backside 3C of the jaw. The teeth 9 extend to a point wherein the half-circle 11 has teeth 9 on all of its surface.

FIG. 5 shows the fourth embodiment of the invention which is an adjustable pliers wherein the backside of the jaw 3C forms a half-circle 11 when the axle point 5 is positioned in the center of the slot 6. The jawed mouth 3 has a series of saw-tooth shaped teeth 9 along the upper 3A, lower 3B and backside 3C of the jaw. The teeth 9 extend beyond the half circle 11 and continue along the straight-edged rim 10 of the second member 2 to a point wherein the teeth 9 would be able to grab any object when the jawed mouth 3 is opened to its fullest extent.

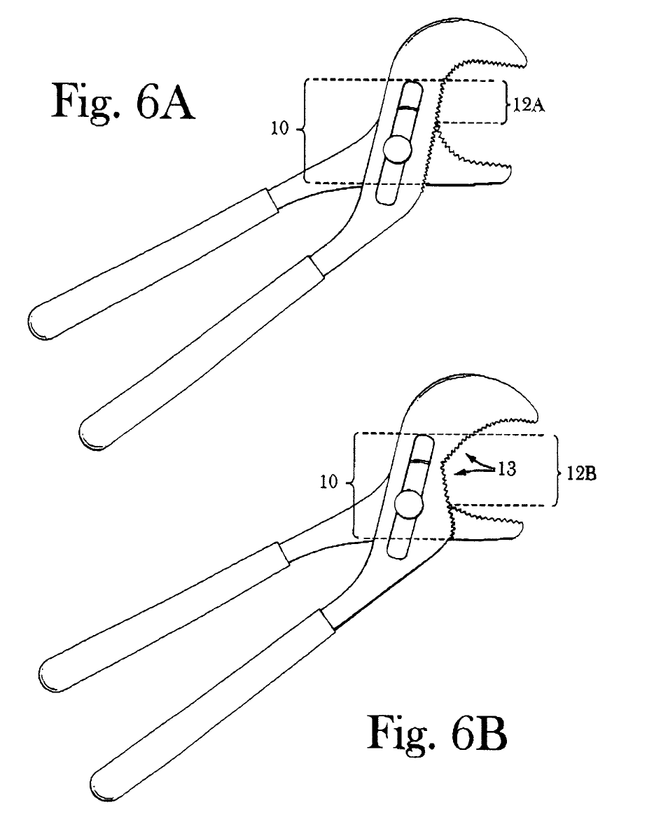

FIG. 6 shows the indentation 12 along the straight-edged rim 10. The indentation 12 is shown both crescent shaped 12A and V-shaped 12B. When V-shaped, the inner angle 13 could range from 100 to 160 degrees.

I claim:

1. An adjustable pliers comprising: two members, each having a first end and a second end, forming a jawed mouth on said first end, handles on said second end and pivot about an axle point, said members each having an inner and outer side, said axle point mounted on said first member on the inner side and said second member having an elongated slot, extending longitudinally down the second member from the jawed mouth to the handle, in which said axle point moves to allow for adjustment of the size of said jawed mouth, said slot having a means for selective positioning of said axle point along said slot, said inner portions of said members containing a guide means comprised of channels along said inner portion of said second member and a notch along said inner portion of said second member, said notch fitting into the selected channel guiding the opening and closing of said mouth, said jawed mouth having a series of saw-tooth shaped teeth along the upper and lower portion of said mouth; said teeth extending down the jaw to a point wherein every portion of the jaw would have a tooth on every section of the jaw when the jaws are opened to their fullest extent.

2. An adjustable pliers comprising: two members each having a first end and a second end forming a jawed mouth on said first end, handles on said second end and pivot about an axle point, said members each having an inner and outer side, said axle point mounted on said first member on the inner side and said second member having an elongated slot, extending longitudinally down the second member from the jawed mouth to the handle, in which said axle point moves to allow for adjustment of the size of said jawed mouth, said slot having a means for selective positioning of said axle point along said slot, said inner portions of said members containing a guide means comprised of channels along said inner portion of said second member and a notch along said inner portion of said second member, said notch fitting into the selected channel guiding the opening and closing of said mouth, said jawed mouth having a series of saw-tooth shaped teeth along the upper and lower portion of said mouth; the back end of the lower jaw section turning upward at such angle as to form one-quarter of a circle and the back end of the upper jaw section turning downward at the same angle, said back ends of the upper and lower jaw sections forming two sloped sections together which form a half-circle when the axle point is positioned at the center of the slot, said half-circle comprising the back end of the jaw.

3. The pliers of claim 2 further comprising additional teeth extending down the two sloped sections allowing the jaw to encircle any round shaped object and grip said object uniformly along half its diameter with said teeth.

4. The pliers of claim 3 wherein the additional teeth continue up both members forming the jaws beyond the point where a half circle is formed along the straight edge to a point wherein the teeth would be able to grab any object when the jaws are opened to their fullest extent.

5. The pliers of claim 4 wherein the second member contains an indentation along the straight edge, said indentation being crescent shaped, and having saw-tooth shaped teeth along its edge.

6. The pliers of claim 5 wherein said indentation is V-shaped, wherein the inner angle of the V is between 100 to 160 degrees.

7. The pliers of claim 6 wherein the inner angle of the V is 150 degrees.
